(19) United States
(12) Patent Application Publication
(10) Pub. No.: US 2020/0154734 A1
(43) Pub. Date: May 21, 2020

(54) TEXTURIZED PROTEIN PRODUCT

(71) Applicant: Gold&Green Foods Oy, Helsinki (FI)

(72) Inventors: Maija ITKONEN, Helsinki (FI); Reetta KIVELÄ, Helsinki (FI); Zhong-Qing JIANG, Helsinki (FI)

(73) Assignee: Gold&Green Foods Oy, Helsinki (FI)

(21) Appl. No.: 16/604,243

(22) PCT Filed: Apr. 10, 2018
(86) PCT No.: PCT/EP2018/059131

§ 371 Date: Oct. 10, 2019

(30) Foreign Application Priority Data
Apr. 11, 2017 (EP) 17166060.8

(51) Int. Cl. A23J 3/14; A23L 7/10; A23J 3/22; A23L 33/185; A23L 33/16; A23L 33/115

(52) U.S. Cl. CPC A23J 3/14; A23L 7/115; A23J 3/227; A23J 3/26; A23L 33/16; A23L 33/115; A23V 2002/00; A23L 33/185

(57) ABSTRACT

The invention relates to a texturized protein product, which is prepared from legume material comprising legume protein and cereal material comprising bran and cereal protein. The product comprises particles having at least partially fibrous structure, where at least 80% of fibres have a length in the range 1-30 mm and a thickness in the range of 5-35 μm. Furthermore, the product comprises at least 70 weight-% of particles having a particle size ≥1 cm and less than 20 weight-% of particles having the particle size ≥4 cm, whereby 100 weight-% of the particles have the particle size ≤7 cm.

The present invention relates to a texturized protein product according to the preamble of the enclosed independent claim.

Recently consumers have been showing a growing interest in sustainable and healthy diet. This has led to an increase in plant-based products that can be used to replace meat in a daily diet. In order to gain a wider acceptance among mainstream consumers these plant-based products, i.e. meat substitutes, should be easy to prepare and provide nutritionally balanced meals. Furthermore, they should provide an appealing and pleasant mouth-feel, even when heated, cooked and/or fried. Generally, it is desired that the appearance and the mouth-feel of the plant-based product should provide the consumer a meat-like experience.

A general problem is that most of the plant-based products are not able to mimic the meaty appearance and mouth-feel in a satisfactory manner. The products can have unpleasant gummy texture, especially when they are heated, and they are not able to provide crispy mouth-feel after frying on a pan. Many of the products, which are provided as meat substitutes, are based on soya, which may induce a beany-taste and rubbery or slimy structure to the product. Some commercially available products are based on mixtures of oat and legumes. These products are more satisfactory in their taste and mouth-feel, but there is a constant need to improve the meat-like appearance and general acceptability of the plant-based products which are intended for use as meat substitutes.

An object of the present invention is to minimise or even eliminate the disadvantages existing in the prior art.

An object of the invention is also to provide a texturized protein product, which provides enhanced mouth-feel and meat-like appearance, even when the product is heated or fried.

Another object of the invention is to provide a texturized protein product, which provides balanced composition, even in view of nutrients and/or micronutrients.

These objects are attained with the invention having the characteristics presented below in the characterising parts of the independent claims.

Typical texturized protein product according to the present invention
is prepared from legume material comprising legume protein and cereal material comprising bran and cereal protein, and
comprises particles having at least partially fibrous structure, where at least 80 (Y0 of fibres have a length in the range 1-30 mm and a thickness in the range of 5-35 μm,

wherein the product comprises at least 70 weight-% of particles having a particle size ≥1 cm and less than 20 weight-% of particles having the particle size ≥4 cm, whereby 100 weight-% of the particles have the particle size ≤7 cm.

Now it has been surprisingly found out that a defined particle size distribution has a major impact in and enhances the mouth-feel of the texturized protein product. It has been observed that the particle size distribution has unexpectedly strong impact on the consumer perception and approval of the product. The particle size distribution according to the present invention was found to provide together with the other properties of the product an enhanced feeling of minced or chopped beef or well-prepared chicken. It is assumed, without wishing to be bound by a theory, that the specified particle size distribution somehow corresponds to the human perception of well-prepared meat and improves the mouth-feel of the product.

In the present context “texturized protein product” is understood as solid fibrous product, which is produced from cereal material and legume material by cooking the starting materials in an extruder cooker and extruding them to form a texturized food product. Suitable production processes are disclosed e.g. in patent applications EP 15190251.7 and PCT/EP2016/074556. It has been observed that the processing parameters, e.g. mixing power, can be suitably adjusted for production of texturized protein product according to the present invention. For example, if the processing is too strong, the particle size may become too small.

It has been observed that the amount of particles in different size categories is important for creating the desired mount-feel and the meat-like illusion. According to one preferable embodiment of the invention the texturized protein product comprises
5-30 weight-%, preferably 8-26 weight-%, more preferably 10-21 weight-% of the particles having the particle size <1 cm;
60-95 weight-%, preferably 66-88 weight-%, more preferably 71-83 weight-% of the particles having the particle size in the range of 1-<4 cm;
0-20 weight-%, preferably 0-16 weight-%, more preferably 0-7 weight-% of the particles having the particle size in the range of 4-7 cm.

The texturized protein product may comprise
10-45 weight-%, preferably 15-40 weight-%, more preferably 20-35 weight-% of the particles having the particle size in the range of 1-<2 cm;
20-50 weight-%, preferably 25-45 weight-%, more preferably 30-40 weight-% of the particles having the particle size in the range of 2-<3 cm;
5-40 weight-%, preferably 10-35 weight-%, more preferably 12-24 weight-% of the particles having the particle size in the range of 3-4 cm.

The particles of the texturized protein product have often an irregular shape. Particle size, in the present context, refers to the largest dimension of a particle, which is measured by drawing a straight line from an outer edge of the particle through the centre of the particle to the opposite edge of the particle.

In the present context the term “cereal” denotes grains from grasses of family Poaceae, excluding however wheat. This means that the texturized protein product is free from wheat. Examples of cereals are oat, barley, rye, rice, corn and any mixture thereof. According to one preferable embodiment the cereal material comprises oat, more preferably the cereal material is oat. Exclusion of wheat makes the ready-to-eat texturized protein product preferably low in gluten, especially wheat gluten, sometimes preferably completely gluten-free. It is surprising that the fibrous texture can be achieved even if the gluten content is low or completely without gluten, especially wheat gluten. According to one embodiment the texturized protein product may contain only minor amounts of gluten, especially wheat gluten, such as <1 weight-%, preferably <0.5 weight-%, more preferably <0.2 weight-%, even more preferably <0.1 weight-%, calculated from the total dry mass of the product.

The term “cereal material” encompasses all different kinds of material fractions obtainable by processing, such as separation, isolation and/or milling, of said cereals. Cereal material may preferably be whole grain material, which is obtained by milling whole grains of cereal. These grains comprise endosperm, grain and bran. Alternatively, cereal material may also preferably be cereal protein isolated from the grain, processed or unprocessed bran isolated from the grain or processed or unprocessed endosperm isolated from the grain. Cereal material encompasses also mixtures of said materials, for example, a mixture of whole grain material and isolated cereal protein. It is possible to optimise the nutrient content of the texturized protein product by appropriately selecting and mixing the above-mentioned starting materials.

According to one embodiment of the invention the texturized protein product comprises cereal protein in total amount in the range of 5-35 weight-%, preferably 7-25 weight-%, more preferably 11-17 weight-%, calculated from the total dry mass of the product. The total amount of cereal protein includes both the natural cereal protein present in the cereal material and optional added isolated cereal protein. It has been observed that this amount of cereal protein provides good nutritional composition as well as easy processability during the production.

The cereal material comprises bran. Bran may originate from the use of whole grain cereal material or it may originate from bran fraction separated from whole grain. According to one preferable embodiment the cereal material comprises whole grain cereal material and/or isolated cereal bran material. It is possible to influence the mouth-feel and/or physical properties of the texturized protein product by careful selection of the type and/or amount of the whole grain material and/or bran material used for preparing the product. For example bran, either isolated or included in the whole grain cereal material, improves the texture of the protein product by optimising it chewability. By changing the amount of bran it is possible to influence the firmness and/or mouth-feel of the product. The product may comprise whole grain cereal material and/or bran, i.e. cereal bran, in amount of 5-44 weight-%, preferably 12-40 weight-%, more preferably 15-26 weight-%, calculated from the total dry mass of the product.

According to one preferable embodiment the cereal is selected from a group consisting of oat, barley, rye, and any mixture of these, preferably oat. By selection of the type of the cereal material or by selection of the cereal and their amounts in a mixture of different cereal materials it is possible to influence the structure and composition of the obtained texturized protein product. According to one preferable embodiment the cereal material comprises oat bran, optionally as a mixture with oat protein. Preferably cereal material comprises at least 50 weight-%, more preferably at least 85 weight-%, of oat material, calculated from the total weight of the cereal material. According to one preferred embodiment the cereal material consists solely of oat. In addition to texture of the product oat bran improves the nutritional composition of the product, e.g. by increasing the amount of beta glucan in the product.

The texturized protein product is free from wheat, and preferably free from wheat protein and/or gluten.

In addition to cereal material the textured protein product is produced from legume material comprising legume protein. In the present context, legume material encompasses both legume material, e.g. legume powder or flour, which contains natural amounts of legume protein, as well as legume material to which has been added isolated legume protein and which contains elevated amounts of legume protein. Suitable legume material is, for example, plants from the family Fabaceae (or Leguminosae), or the fruit or seed of such a plant. Suitable legume material include alfalfa, clover, different species of peas, different species of beans, different species of Vicia fabas, lentils, lupins, mesquite, carob, peanuts and tamarind. Preferably legume material is selected from species of peas and Vicia fabas, most preferably from species of peas.

The texturized protein product is preferably free from soy, soy protein, soy-based material and/or soy derived components. It is unexpected that a texturized product with high protein content can be prepared without using soy or soy-based material. The possibility to exclude soy is advantageous, because soy is relatively allergenic. Furthermore, exclusion of soy makes it easier to produce products that are free from organisms whose genetic material has been altered using genetic engineering techniques, i.e. GMO-free products.

According to one embodiment of the invention the texturized protein product comprises legume protein in total amount in the range of 35-60 weight-%, preferably 37-55 weight-%, more preferably 41-51 weight-%, calculated from the total dry mass of the product. The total amount of legume protein includes both the natural legume protein present in the legume material and optional added isolated legume protein.

The texturized protein product may be prepared from 50-70 weight-%, preferably 56-66 weight-%, of legume material, and 30-50 weight-%, preferably 34-44 weight-%, of cereal material, calculated as dry matter. Legume material and cereal material in the product may be carefully selected not only in order to provide optimal structure for the product but also for providing the texturized protein product with optimal amounts of various micronutrients.

According to one preferable embodiment the texturized protein product is completely free from animal-based constituents, such as meat, animal fats, milk, skin, gelatine, eggs and blood. This makes the product suitable for all consumer groups, irrespective for their religious and/or ethical beliefs. This means that there is no need to modify the basic recipe of the product depending on the specific market segment requirements.

The texturized protein product may have a bulk density of at least 0.15 g/ml, preferably at least 0.3 g/ml. The bulk density may be in the range 0.15-1.5 g/ml, preferably 0.24-1.2 g/ml, more preferably 0.3-1.0 g/ml, even more preferably 0.4-0.8 g/ml. Bulk density can be determined by 1) taking a defined amount of a sample, between 40-50 g; 2) cutting/chopping the sample into particles having a largest dimension between 3-5 mm; 3) measuring the exact weight of the cut/chopped sample; 4) measuring the volume of the sample; and 5) calculating the bulk density.

Furthermore, it has been observed that the particle size distribution is an important parameter for controlling the oil absorption rate of the texturized protein product. This means that it is possible to change the oil absorption rate by modifying the particle size distribution, as the small particles (<2 g) absorb more oil than large particles (>10 g). According to one embodiment of the invention the texturized protein product, having a particle size distribution as defined above, may have an oil absorption ratio in the range of 8-45%, preferably 13-35%, more preferably 14-30%. The oil absorption is measured as follows:

(1) weigh a desired amount of product sample, typically ca 250 g, and record the result as the “Original weight”;

(2) immerse the sample into edible liquid oil, such as rapeseed oil, in a beaker-like container, at room temperature;

(3) after a defined period of time (minimum 15 min) separate the sample (which now contains absorbed oil) from the rest of the oil by sieving or filtering;

(4) weigh the sample containing absorbed oil and record the result as “Weight after absorbing oil”.

The oil absorption ratio can then be calculated by using the equation:

$$absorption ratio = \frac{Weight after absorping oil - Original weight}{Original weight} \times 100 \%$$

If the oil absorption ratio is too high, an excessive amount of oil is needed during the cooking to obtain an even wetting of the surfaces of the product particles by oil. On the other hand, if the oil absorption is low, the desired cooking effect, e.g. the formation of a crispy surface on the product particles, may not be achieved.

It is also possible to determine the oil absorption ratio for individual particle size categories. According to one embodiment of the invention the particles of the textured protein product having weight <2 g have an oil absorption ratio in the range of 20-45%, preferably 25-40%; the particles of the textured protein product having weight 2-4 g have an oil absorption ratio in the range of 10-30%, preferably 15-25%; and the particles of the textured protein product having weight >4 g have an oil absorption ratio in the range of 8-28%, preferably 13-23%.

Texturized protein product comprises particles having at least partially fibrous structure. The fibres are formed during the manufacturing process from the used raw materials, i.e. legume material and cereal material. The fibres are proteinaceous fibres, which are formed from the proteins contained in the raw materials. The individual fibres of the product may have a thickness in the range of 5-35 μm. The length of the individual fibres is at least partially dependent on the size of the product particles and may be in the range of 35-30-000 μm. The proteinaceous fibres are preferably three-dimensionally entangled, and the fibrous structure preferably comprises voids between the proteinaceous fibres. The three-dimensional entanglement of the proteinaceous fibres means that the texturized protein product preferably comprises proteinaceous fibres of which >20%, more preferably >30%, even more preferably >40%, are at the angle of 35-90°, preferably 40-90°, in relation to each other. The fibre direction measurement is done by a taking an arbitrary sample of 10 mm×10 mm, and then visually assessing the fibre directions. The fibre direction may also be assessed by using an imagining system, such as micro-computed tomography scanner. The three-dimensional entanglement of the proteinaceous fibres provides a product which has uniform cutting shear resistance in every direction, which greatly improves the mouth-feel of the product. According to one embodiment of the invention the difference in cutting shear resistance values in three perpendicular directions is less than 30%, preferably less than 20%, more preferably less than 10%.

According to one embodiment of the invention the texturized protein product comprises vegetable oil, such as rape seed oil, sun flower oil, olive oil or any mixture thereof. Vegetable oil may be added to the texturized protein product in order to improve its fatty acid content.

Furthermore, the texturized protein product has carbohydrates to protein ratio <1, preferably <0.5, more preferably <0.35. This ratio is beneficial when the product is used as a part of diet for weight-control purposes. Carbohydrates to protein ratio of the texturized protein product is also advantageous for maintain and/or increasing muscle mass and for bone health.

According to one embodiment of the invention the texturized protein product may comprise potassium in amount of 400-1600 mg, preferably 600-1200 mg, more preferably 660-1000 mg, and/or magnesium in amount of 80-220 mg, preferably 100-180 mg, more preferably 140-160 mg, given per 100 g of dry product. For example, the magnesium amount in the protein product provides necessary supply of magnesium for persons leading physically active lifestyle.

The texturized protein product may further comprise zinc in amount of 2-20 mg, preferably 4-14 mg, more preferably 5-10 mg; phosphorus in the amount of 600-1200 mg, preferably 840-1000 mg; and/or iron in the amount of 6-20 mg, preferably 8-16 mg, given per 100 g dry product. These values provide a balanced composition of necessary nutrients in the protein product.

Preferably the texturized protein product comprises less than 1 μg/g of acrylamide. This means that the texturized protein product also fulfils the requirements of food regulations.

The texturized protein product may further comprise taste enhancers, such as salt and/or spices. The amount of taste enhancers may be less than 15 weight-%, preferably less than 10 weight-%, more preferably less than 8 weight-%, calculated from the total dry mass of the product. It has been observed that addition of suitable taste enhancers may also improve the storage properties of the product and/or improve the frying properties of the product by creating a crispy surface feeling.

The moisture content of the textured protein product may be in the range of 40-60 weight-%, preferably 49-54 weight-%, more preferably 50-52 weight-%.

The texturized protein product may have a water activity a_{w} in the range 0.920-0.980, preferably 0.925-0.955. This means that the protein product has a good microbial stability and long shelf life.

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. A texturized protein product prepared from a legume material, the texturized protein product comprising:
a legume protein and a cereal material comprising bran and a cereal protein, excluding wheat; and
particles having at least a partially fibrous structure,
wherein at least 80% of fibres have a length in a range 1-30 mm and a thickness in a range of 5-35 μm, and
wherein the product comprises at least 70 weight-% of the particles having a particle size ≥1 cm and less than 20 weight-% of the particles having a particle size ≥4 cm, whereby 100 weight-% of the particles have a particle size ≥7 cm.

2. The texturized protein product according to claim 1, wherein the product is free of soy and/or soy-based material.

3. The texturized protein product according to claim 1, wherein the product comprises:
5-30 weight-%, preferably 8-26 weigh more preferably 10-21 weight-% the particles having a particle size <1 cm;
60-95 weight-%, preferably 66-88 weight-%, more preferably 71-83 weight-% of the particles having a particle size in a range of 1-<4 cm; and
0-20 weight-%, preferably 0-16 weight-%, more preferably 0-7 weight-% of the particles having a particle size in a range of 4-7 cm.

4. The texturized protein product according to claim 1, wherein the product comprises:
10-45 weight-%, preferably 15-40 weight-%, more preferably 20-35 weight-% of the particles having a particle size in a range of 1-<2 cm;
20-50 weight-%, preferably 25-45 weight-%, more preferably 30-40 weight-% of the particles having a particle size in a range of 2-<3 cm; and
5-40 weight-%, preferably 10-35 weight-%, more preferably 12-24 weight-% the particles having a particle size in a range of 3-4 cm.

5. The texturized protein product according to claim 1, wherein the fibres are three-dimensionally entangled, and the fibrous structure preferably comprises voids between the fibres.

6. The texturized protein product according to claim 1, wherein the product has an oil absorption ratio in a range of 8-45%, preferably 13-35%, more preferably 14-30%.

7. The texturized protein product according to claim 1, wherein the product further comprises vegetable oil, such as rape seed oil, sun flower oil, olive oil.

8. The texturized protein product according to claim 1, wherein the product has carbohydrates to protein ratio <1, preferably <0.5, more preferably <0.35.

9. The texturized protein product according to claim 1, wherein the product further comprises:
potassium in an amount of 400-1600 mg, preferably 600-1200 mg, more preferably 660-1000 mg, and/or
magnesium in an amount of 80-220 mg, preferably 100-180 mg, more preferably 140-160 mg, given per 100 g dry product.

10. The texturized protein product according to claim 1, wherein the product further comprises:
zinc in an amount of 2-20 mg, preferably 4-14 mg, more preferably 5-10 mg, and/or
phosphorus in an amount of 600-1200 mg, preferably 840-1000 mg, and/or
iron in an amount of 6-20 mg, preferably 8-16 mg, given per 100 g dry product.

11. The texturized protein product according to claim 1, wherein the cereal material is selected from a group consisting of oat, barley, rye and any mixture of these, preferably oat.

12. The texturized protein product according to claim 1, wherein the cereal material further comprises whole grain cereal and cereal bran.

13. The texturized protein product according to claim 1, wherein the product is free of animal-based constituents.

14. The texturized protein product according to claim 1, wherein the product is prepared from 50-70 weight-%, preferably 56-66 weight-%, of the legume material and 30-50 weight-%, preferably 34-44 weight-%, of the cereal material, calculated as dry matter.

15. The texturized protein product according to claim 1, wherein the product comprises the cereal protein in a range of 5-35 weight-%, preferably 7-25 weight-%, more preferably 11-17 weight-%; and/or the legume protein in a total amount in a range of 35-60 weight-%, preferably 37-55 weight-%, more preferably 41-51 weight-%, calculated from a total dry mass of the product.

16. The texturized protein product according to claim 1, wherein 4 the product comprises bran in an amount of 5-44 weight-%, preferably 12-40 weight-%, more preferably 15-26 weight-%, calculated from a total dry mass of the product.

17. The texturized protein product according to claim 1, wherein 4 the product comprises less than 1 μg/g of acrylamide.
